(19) United States
(12) Patent Application Publication
(10) Pub. No.: US 2014/0030470 A1
(43) Pub. Date: Jan. 30, 2014

(54) High-Strength, Light-Weight, Molded Polymer Articles and Method of Manufacture

(71) Applicant: G & G INDUSTRIES, (US)

(72) Inventors: Brian M. Gantner, Shelby Township, MI (US); Henry J. Opie, White Lake, MI (US)

(73) Assignee: G & G INDUSTRIES, Shelby Township, MI (US)

(21) Appl. No.: 13/648,118

(22) Filed: Oct. 9, 2012

Related U.S. Application Data
(60) Provisional application No. 61/543,882, filed on Oct. 6, 2011.

(51) Int. Cl. B32B 3/04; B29C 70/68

(52) U.S. Cl. CPC B32B 3/04; B29C 70/68
USPC 428/76; 156/196

(57) ABSTRACT

A molded polymer panel includes a core having a portion including a periphery and a reinforcement layer having a first portion and a second portion. The reinforcement layer first portion envelopes the core first portion. The reinforcement layer second portion extends beyond the core periphery. A curable layer having a first portion and a second portion is intermingled with the reinforcement layer. The core first portion, reinforcement layer first portion, and the curable layer first portion form a sandwich core zone. The reinforcement layer second portion and the curable layer second portion form a stiffened zone.

### CROSS-REFERENCE TO RELATED APPLICATIONS

This application claims the benefit of U.S. provisional Application No. 61/543,882 filed Oct. 6, 2011, the disclosure of which is incorporated in its entirety by reference herein.

### TECHNICAL FIELD

At least one embodiment relates to a high-strength, light-weight molded polymer article and method of manufacture of same.

### BACKGROUND

Regulations and fuel costs drive vehicle manufacturers to reduce weight in their vehicles. But, a contradiction arises because use of certain new processes and materials that lighten components of vehicles result in reduction of desirable performance properties of those components, such as strength and heat sag resistance. Mechanical designs applied to remedy these problems often add weight back into the component which is costly and aggravates the heat sag problem. What is needed is a solution that takes full advantage of weight reductions without loss of performance properties while not wasting materials where they are not needed.

### SUMMARY

In at least embodiment, a molded polymer panel includes a core having a portion including a periphery and a reinforcement layer having a first portion and a second portion. The reinforcement layer first portion envelopes the core first portion. The reinforcement layer second portion extends beyond the core periphery. A curable layer having a first portion and a second portion is intermingled with the reinforcement layer. The core first portion, reinforcement layer first portion, and the curable layer first portion form a sandwich core zone. The reinforcement layer second portion and the curable layer second portion form a stiffened zone.

In another embodiment, a molded polymer panel includes a core having a first surface and a second surface opposed and spaced apart from the first surface. A first reinforcement layer is disposed adjacent to the first surface of the core. A second reinforcement layer is disposed adjacent to the second surface of the core. An insert is disposed adjacent to the first reinforcement layer and the first surface of the core. The insert and the first reinforcement layer defining a cavity. A cured polymer layer encapsulates the first and second reinforcement layers and the insert. The cavity is substantially devoid of the cured polymer layer. The average panel stiffness ranges from 4.04 N/mm of panel thickness/kg of panel to 5.29 N/mm of panel thickness/kg of panel.

In another embodiment, a method of manufacturing a panel includes encapsulating a core with a reinforcement layer forming a prepack. A thermoset layer is applied to the reinforcement layer to form a wetted pre-pack. The wetted pre-pack is placed into a mold portion. A pre-molded insert is placed on to the wetted pre-pack. The pre-molded insert and the wetted pre-pack defining a cavity substantially devoid of the thermoset layer. The mold portion is closed and pressure is applied to form a molded panel. The thermoset layer is cured. The mold is opened to remove the molded panel.

### DESCRIPTION OF THE DRAWINGS

FIG. 1 schematically illustrates molded polymer panels in a vehicle according to at least one embodiment;

FIGS. 2A-2F schematically illustrate fragmentary cross-sectional views of molded polymer panels according to at least one embodiment;

FIGS. 3A-3B schematically illustrate fragmentary cross-sectional views of molded polymer panels according to at least one other embodiment;

FIG. 4 schematically illustrates a fragmentary cross-sectional view of a molded polymer panel according to at least one other embodiment;

FIG. 5 diagramatically illustrates a process for manufacturing a molded polymer panel according to at least one embodiment;

FIG. 6 graphically illustrates mechanical properties of a molded polymer panel according to at least one embodiment; and

FIG. 7 diagramatically illustrates a process for manufacturing a molded polymer panel according to at least one embodiment.

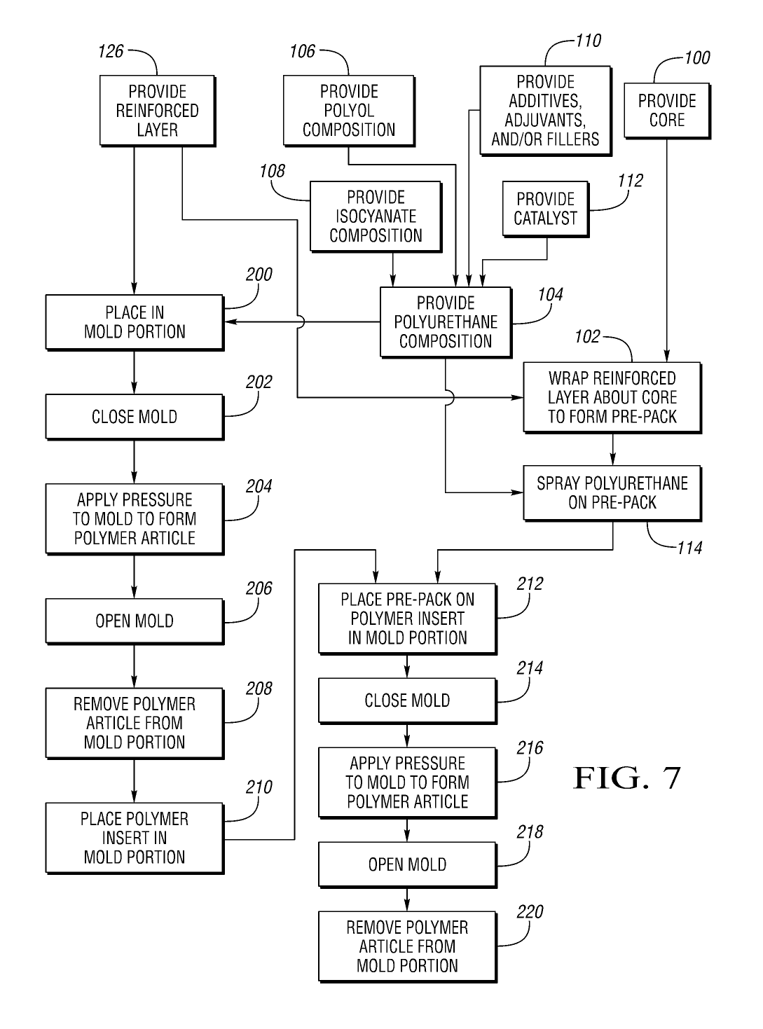

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

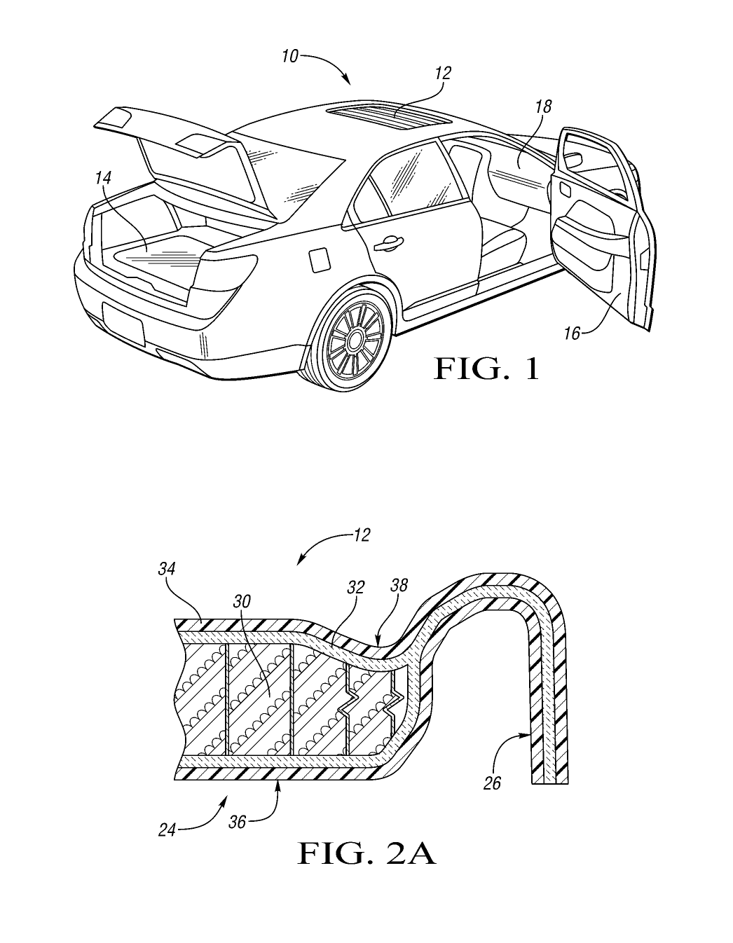

FIG. 1 schematically illustrates a vehicle 10 having one or more high-strength, light-weight, molded polymer panels, such as a sunroof shade 12, a load floor 14, as well as trim parts, such as an interior door panel 16, and an interior dashboard panel 18.

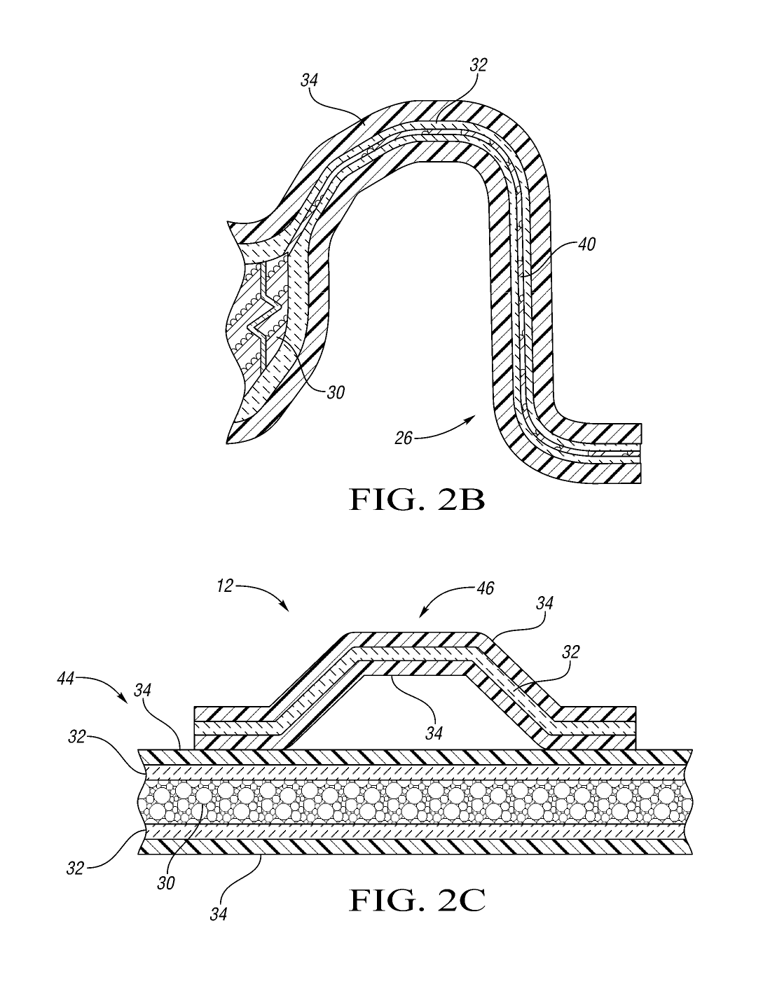

FIG. 2A schematically and exemplarily illustrates a fragmentary cross-sectional view of the sunroof shade 12. Sunroof shade 12 has a sandwich core zone 24 and a stiffened zone 26. Sandwich core zone 24 includes a core 30, a reinforcement layer 32, and a curable layer 34. In at least one embodiment, sandwich core zone 24 forms an I-beam structural member.

In sandwich core zone 24, reinforcement layer 32 contacts all or a portion of core 30. At least one embodiment, reinforcement layer 32 encapsulates core 30. In another embodiment, reinforcement layer 32 is bonded to core 30. In yet another embodiment, reinforcement layer 32 forms a balanced composite with core 30. In another embodiment, reinforcement layer 32 forms an unbalanced composite with core 30.

In sandwich core zone 24, curable layer 34 contacts reinforcement layer 32. In at least one embodiment, curable layer 34 and reinforcement layer 32 are at least partially co-mingled. In at least one embodiment, curable layer 34 contacts at least portions of reinforcement layer 32 and core 30.

In at least one embodiment, sandwich core zone 24 includes an uncompressed core subzone 36 schematically illustrated where core 30 experiences essentially no compression when placed in a mold when the mold experiences a compressive pressure. In at least one embodiment, the uncompressed core subzone 36 compresses less than 10% of its original thickness. In another embodiment, the uncompressed cores subzone 36 does not experience buckling.

In at least one embodiment, sandwich core zone 24 includes a compressed core subzone 38 schematically illustrated where core 30 experiences compression of core 30 by at least 10% of its original thickness. In at least one embodiment, core 30 buckles when compressed in a mold.

Stiffened zone 26 includes reinforcement layer 32 and curable layer 34. In at least one embodiment, stiffened zone 26 includes a stiffening core 40 as schematically illustrated in FIG. 2B. In at least one embodiment, stiffening core 40 connects with core 30 and is thinner than core 30. In another embodiment, stiffening core 40 has an identical composition to a composition of core 30. In yet another embodiment, stiffening core 40 includes a composition different from the composition of core 30. In yet another embodiment, stiffening core 40 includes a second composition, such as a ceramic or metallic insert.

Turning now to FIG. 2C, another embodiment of the sunroof shade 12 is schematically and exemplarily illustrated in a fragmentary cross-sectional view. Sunroof shade 12 has a sheet 44 having core 30, reinforcement layer 32, and curable layer 34. Molded to sheet 44 is a profile 46 having a curable layer 34 and a reinforcement layer 32. Profile 46 is a molded polymeric insert which is inserted into a mold portion 48 and sheet 44 is connected to a portion of the profile 46 in mold 48. Profile 46 is bonded to sheet 44 in mold 48 when sheet 44 cures in mold 48. Profile 46 and sheet 44 define a cavity 92. Cavity 92 is substantially devoid of curable layer 34. While not wishing to be bound by any theory, being substantially devoid of curable layer 34, in certain embodiments, uses significantly less materials, while making a structurally stronger construction with a corrugation effect, forming a lighter, stronger molded polymer panel.

It should be understood that curable layer 34 of profile 46 may have the same composition or a different composition from curable layer 34 of sheet 44. It should also be understood that reinforcement layer 32 of profile 46 may have the same composition or a different composition from reinforcement layer 32 of sheet 44. It should be further understood that profile 46 may also include an optional core 30, which may have a same composition and/or initial thickness or a different composition and/or initial thickness from core 30 of sheet 44.

Core 30 may include materials known in the art. In at least one embodiment, core 30 comprises a reinforced layer. In at least one embodiment, core 30 may be selected from, but not limited to, a group consisting of a vertical cell wall structure; a honeycomb core, including a honeycomb formed of corrugated cardboard or paper; a phenolic impregnated honeycomb; a natural fiber mat; a foamed polymer, such as a foamed polyurethane, polyurea, and/or polyisocyanurate; wood, including balsa wood; thermoplastic sandwich core material, including divinycell P provided by Diab® or polypropylene; glass-reinforced plastic; carbon fiber reinforced plastic; aramid paper reinforced plastic, including Nomex® provided by Dupont® and metal mesh, including aluminum honeycomb structures.

In at least one embodiment, core 30 has a thickness ranging from 2 mm to 150 mm before compression. In another embodiment, core 30 has a thickness ranging from 5 mm to 50 mm before compression. In yet another embodiment, core 30 has a thickness ranging from 10 mm to 30 mm before compression.

In at least one embodiment, core 30 has a thickness ranging from 0.5 mm to 90 mm after compression in a mold. In another embodiment, core 30 has a thickness ranging from 1.5 mm to 50 mm after compression in a mold. In yet another embodiment, core 30 has a thickness ranging from 2 mm to 30 mm after compression in a mold. In yet another embodiment, core 30 has a thickness ranging from 5 mm to 22 mm after compression in a mold.

In at least one embodiment, core 30 has a maximum width or length ranging from 5 mm to 3 m. In another embodiment, core 30 has a maximum width or length ranging from 25 mm to 125 mm. In yet another embodiment, core 30 has a maximum width or length ranging from 50 mm to 100 mm.

In at least one embodiment, curable layer 34 comprises a composition that is curable by a method that includes, but is not limited to, radiation curing or thermal curing, such as a thermoset resin. Examples of the thermoset resin include, but are not limited to, heterochain polymers, homochain polymers, condensation polymers, and step-reaction polymers. Heterochain polymers may include, but are not limited to, polysiloxane compositions, polyimine compositions, polyimide compositions, polyamide compositions, polyester compositions, polyurea compositions, and polyurethane compositions. In at least one embodiment, curable layer 34 is a cured polymeric resin. In at least one embodiment, curable layer 34 comprises a cured polyether polyurethane formed using methylene diphenyl diisocyanate (MDI).

In at least one embodiment, curable layer 34 comprises a composition that is semi-rigid or rigid when cured. In at least one embodiment, curable layer 34 has a tensile strength after curing of at least 250 kPa when tested according to ASTM D-1623. In another embodiment, curable layer 34 has a tensile strength ranging from 260 kPa to 500 kPa.

In at least one embodiment, curable layer 34 may be applied to reinforcement layer 32 by spraying, roller application, third-stream long fiber injection or dipping. In at least one embodiment, curable layer 34, when applied, may range in weight coverage from 200 g/m² to 2000 g/m². In another embodiment, curable layer 34, when applied, may range in weight coverage from 250 g/m² to 1000 g/m². In yet another embodiment, curable layer 34, when applied, may range in weight coverage from 300 g/m² to 600 g/m². In at least one embodiment, the weight coverage may vary in a gradient or a localized increase or decrease in weight. Non-limiting examples of variation in curable layer 34 coverage includes placing more curable layer 34 material about embossments having at least 1.5 times to 3.5 times the height relative to the immediately surrounding surfaces; or placing less curable layer 34 material in stiffened zone 26.

In at least one embodiment, curable layer 34 may include fillers, adjuvants, and/or additives. Examples of fillers may include, but are not limited to, inert particles, reactive particles, calcium carbonate, glass microspheres, microballoons, and plastic particles. Examples of adjuvants may include, but are not limited to, surfactants and in-mold release (IMR) agents. Examples of additives may include, but are not limited to, pigments, colorants and foaming agents, such as endothermic foaming agents, exothermic foaming agents, injected compressed gas, and gas formed in-situ.

In at least one embodiment, the high-strength, low weight polymer article, such as the sunshade 12, may use a lightweighting agent to reduce the weight of curable layer 34. Non-limiting examples of the lightweighting agent include glass microspheres, microballoons, and/or foaming agents In at least one embodiment, the weight of curable layer 34, as measured by a density of curable layer 34, is reduced in a range from 5% to 40% relative to the uncured composition. In another embodiment, the weight of curable layer 34 is reduced in a range from 10% to 35%. In yet another embodiment, the weight of curable layer 34 is reduced in a range from 20% to 30%.

In at least one embodiment, curable layer 34 cohesively bonds to reinforcement layer 32 and to other portions of curable layer 34, when molded separately such as is in forming profile 46. In FIG. 2D, another embodiment of sunroof shade 12 is schematically and exemplarily illustrated in a fragmentary cross-sectional view where profile 46 is a pre-molded insert. In at least one embodiment, a first curable layer 34 is applied to one surface of reinforcement layer 32, and a curable layer 90 is applied to the other surface of reinforcement layer 32. In another embodiment, in FIG. 2E two or more profiles 46 are bonded on opposed surfaces of core 30. In yet another embodiment in FIG. 2F, insert 46 is positioned on a surface of core 30, but a curable layer 94 is applied only to a portion of the interface with core 30 that is beyond insert 46. In at least one embodiment, curable layer 34 is preferentially thicker about the insert 46. These embodiments illustrate the benefit of either conducting a preliminary action, such as pre-molding insert 46, or reducing the amount of material used. Certain prior art units that do not use the preliminary action, fill the entire space, or at least a significant portion of the space, between the insert 46 and core 30 with curable layer 34. Such a prior art one-shot molding process, though desirable in labor content, wastes material, increases the component weight, and uses more machine time because the thicker curable layer 34 requires disproportionally longer to cure. The prior art units have unacceptable performance properties.

At least one embodiment when forming polymer articles, such as sunshade 12, curable layer 34 of sheet 44 cohesively bonds to other portions of curable layer 34 of profile 46 when an in-mold release agent (IMR) rises to a bonding surface of curable layer 34 in an amount less than 25 wt. % of the IMR in the curable layer 34 composition. At least one embodiment, curable layer 34 cohesively bonds to other portions of curable layer 34 when the IMR agent rises to a bonding surface of curable layer 34 in a range of 1 wt. % to 15 wt. % of the IMR in the curable layer 34 composition. In at least one embodiment, curable layer 34 cohesively bonds to other portions of curable layer 34 when the IMR agent rises to a bonding surface of curable layer 34 in a range of 5 wt. % to 10 wt. % of the IMR in the curable layer 34 composition. Unexpectedly, having an internal mold release does not interfere with the bonding of curable layer 34 to other portions of curable layer 34.

In at least one embodiment, when processing curable layer 34 to form a cured layer, a time from initiating cure until gel time (i.e. an open time) ranges from 10 seconds to 120 seconds. In another embodiment, when processing curable layer 34, the time from initiating cure until gel time ranges from 25 seconds to 90 seconds. Having the relatively thin cross-sections of the component part, such as sunshade 12, in combination with the reduced amount of curable resin 34, in certain embodiments, increases the processing rate cycle time. This is not available to prior art parts made with more curable resin content or those requiring thicker cross-sectional areas to provide acceptable performance properties.

In at least one embodiment, reinforcement layer 32 reinforcement may be selected from a group, but not limited to that group, including fiberglass, such as A-glass, C-glass, E-glass, and S-glass; carbon fiber; aramid fiber; polyolefin fiber; oriented fiber; basalt fiber; and natural fiber. Reinforcement layer 32 in at least one embodiment may include a woven or a non-woven reinforcement fabric, as well as a blended woven and non-woven reinforcement fabric, or a third-stream chopped fiberglass, such as long fiber injection (LFI) provided by Krauss-Maffei®. Woven reinforcement may include, but is not limited to, 0/90 cross woven mat, 45/45 cross woven mat, a triaxially woven mat, and mat with strands having one composition going in one direction and a second composition going in a second direction, such as carbon fiber cross woven with fiberglass or aramid fiber cross woven with carbon fiber. Non-woven reinforcement fabric may include, but is not limited to, continuous fiber mat (CFM), chopped strand mat (CSM), and veil mat. Blended woven and non-woven reinforcement fabric may include, but is not limited to, a needled fabric or a bonded fabric, such as a fabric having 36 ounce cross woven mat bonded to 1.5 ounce CSM as supplied as 3615 fiberglass fabric by Owens-Corning®.

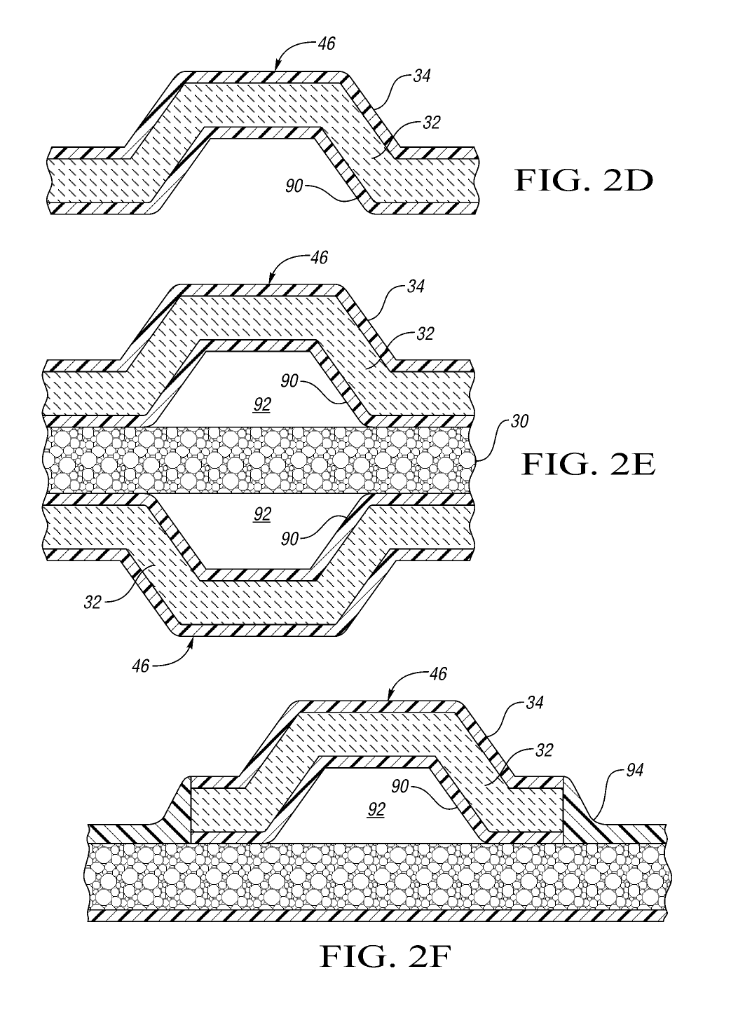

Turning now to FIGS. 3A and B, a fragmentary cross-sectional view of load floor 14 is schematically illustrated with insert 50. In FIG. 3A, insert 50, such as a hinge pin, includes a fiberglass core 52 encapsulated by a thermoset layer 54. Insert 50 is added to the mold before loading a pre-pack and molding in the mold. It should be understood that thermoset layer 54 and curable layer 34 may remain separate or may be intermixed without exceeding the scope or spirit of embodiment.

It is understood that while a hinge pin is illustrated, any suitable insert may be molded into the polymer article including a metal bar or an in-mold decoration.

FIG. 3B schematically illustrates a fragmentary cross-sectional view of load floor 14 where insert 50 is formed from a stiffened zone 56 which is unitized with load floor 14 by forming during molding at the same time that load floor 14 is formed. Using insert 50 in combination with the reduced curable layer 34 resin usage unexpectedly results in a sufficiently stiff component that resists heat sag and supports the use of thinner cross-sections for the components. Certain prior art components were burdened with the extra weight of full-length metal inserts to gain sufficient stiffness for the component to be usable.

Load floor 14 may have a thickness up to 125 mm in at least one embodiment. In another embodiment, load floor 14 may have a thickness ranging from 15 mm to 75 mm. In yet another embodiment, load floor 14 may have a thickness ranging from 25 mm to 50 mm.

Load floor 14 may also have a decorative layer 58, such as a carpet layer, bonded to curable layer 34. It is understood that decorative layer 58 may be bonded in-situ during the molding operation or as a secondary lamination operation.

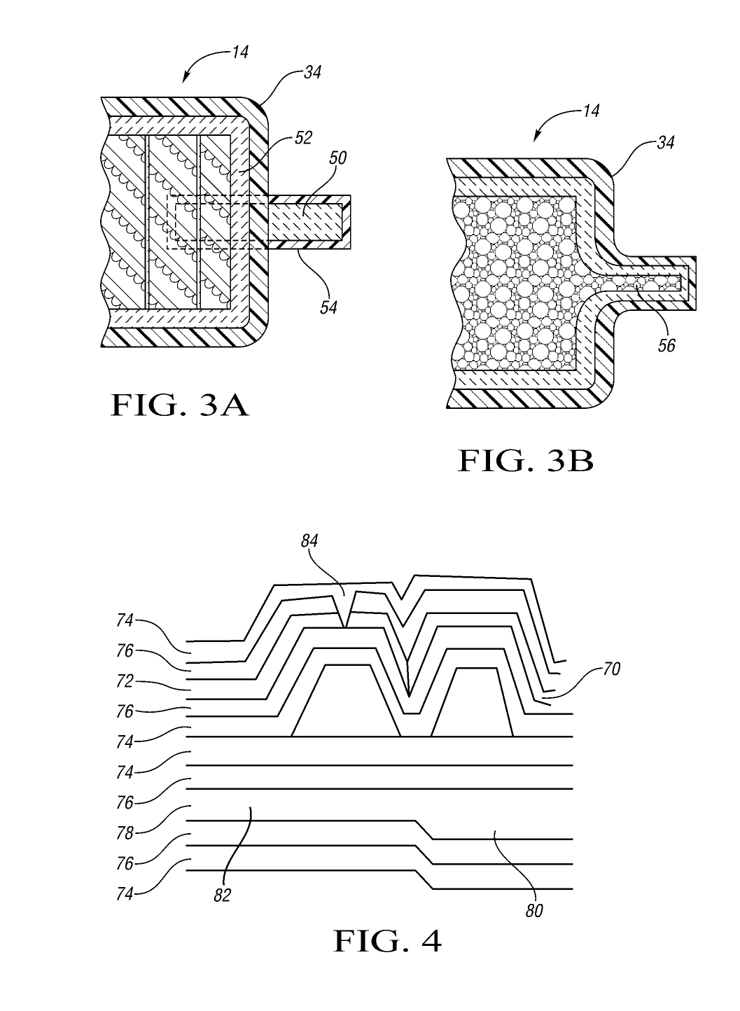

Turning now to FIG. 4, a fragmentary cross-sectional view of a polymer article schematically illustrates ribs, such as for a cross-brace or an annular ring, having at least two different types of cores 70 and 72. Core 70 is a vertical cell wall, post-consumer recycled honeycomb having a relatively high-strength to weight ratio relative to the rib made with core 72, which is a balsa wood core. The polymer article formed of a polyurethane layer 74 encapsulating a fiberglass reinforcement layer 76 and a foam core 78 is unexpectedly capable of adjusting the strength to weight ratio of the article by adjusting the thickness of foam core 78 and cooperating with the strength to weight ratio of the rib sections, as needed.

In at least one embodiment, polyurethane layer 74 seeps into vertical cell post-consumer recycled honeycomb 70 during molding as shown on page 84.

It should be understood that while sunroof shade 12 and load floor 14 embodiments have been illustrated, other embodiments of the polymer article may be suitable in other applications such as in, but not limited to, construction and furniture industries. Non-limiting examples of construction industry polymer articles include doors, garage doors, and wall panels. Non-limiting examples of furniture industry polymer articles includes seat back and a desk surface.

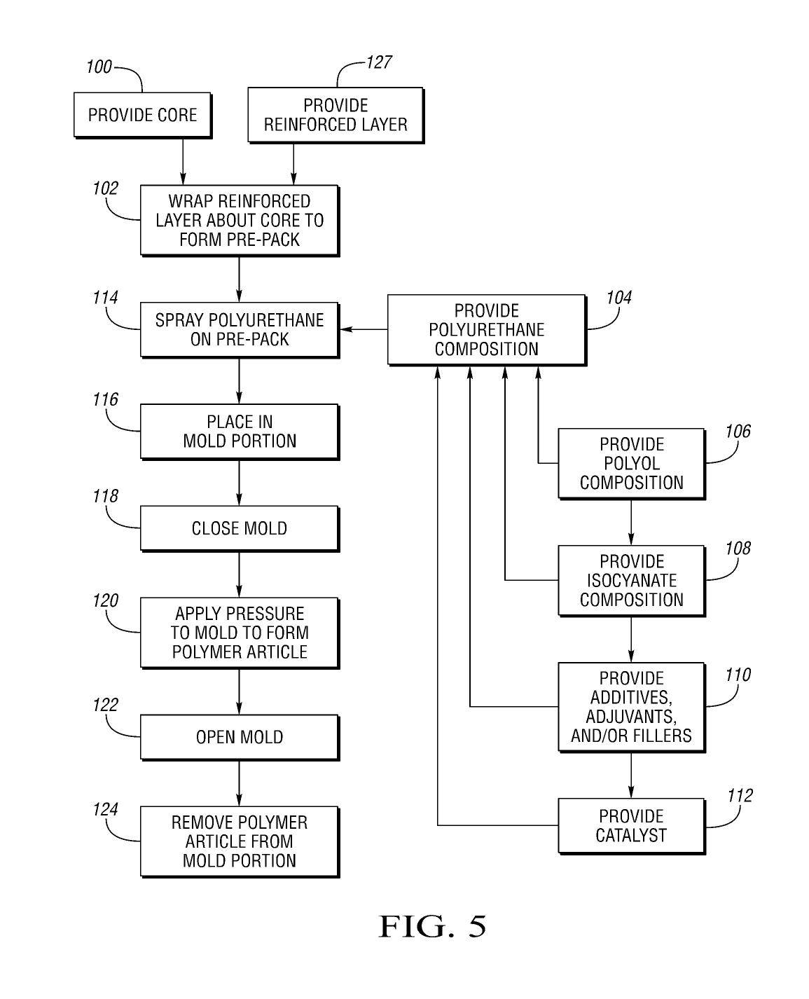

Turning now to FIG. 5, an embodiment of a method of manufacture of the high-strength, light-weight polymer article is illustrated. In step 100, a core and a reinforcement layer are provided. In step 102 the reinforcement layer is wrapped about to form the pre-pack. In step 104, a sprayable polyurethane composition is formed by combining a polyol, a diisocyanate, adjuvants, additives, and fillers, as well as a catalyst from sources 106, 108, 110, and 112.

In step 114, the polyurethane composition is sprayed as a coating layer on the pre-pack. In step 116, the coated pre-pack is placed in a first mold portion having either an “A” surface or a “B” surface. In step 118, at least one other mold portion is closed on the first mold portion to form the closed mold. In step 120, pressure is applied to the closed mold to cause the core and reinforcement layer to take the shape of the mold as well as to allow the polyurethane composition to flow or expand in order to form a surface of the polymer article and to fill the “A” surface features of the mold. The curable layer 34 is cured. In step 122, the mold is opened. In step 124, the polymer article is removed from the mold.

While FIG. 5 illustrates a sprayable polyurethane composition and certain core and reinforcement layer compositions, it should be understood that any other suitable application method for curable layer and other compositions for the core and reinforcement layer may be used without exceeding the scope or spirit of embodiments.

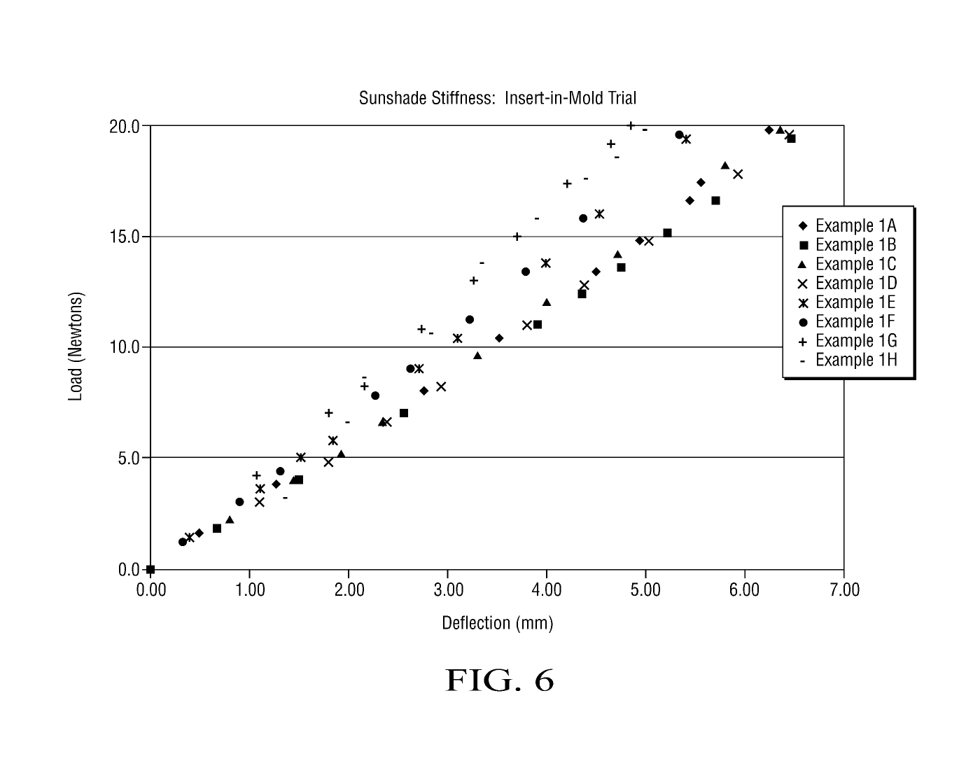

Turning now to FIG. 6, another embodiment of a method of manufacture of the high-strength, light-weight polymer article is illustrated. In step 100 and reinforced layer is provided. In step 104, the polyurethane composition is sprayed on the reinforced layer emplaced in the mold step 200. In step 202, the mold disclosed. In step 204, pressure is applied to the mold to form a polymer insert. In step 206, the mold is opened. In step 208 the polymer insert is removed from the mold portion. In step 210 the polymer insert is placed into another mold portion.

In at least one embodiment, curable layer 34 is preferentially thicker about the insert 46.

In step 100, a core and a reinforced layer are provided. In step 102 the reinforced layer is wrapped about the core layer to form a pre-pack. In step 104 a polyurethane composition is provided in sprayed on the polyurethane pre-pack in step 114. In step 212, the pre-pack is placed on the polymer insert in the mold portion. In step 214, the mold is closed. In step 216, pressures applied to the mold to form the polymer article. In step 218, the mold is opened. In step 220, the polymer article is removed from the mold portion. The polymer article is a unitized combination of the polymer insert and a backsheet, such as sandwich cores zone 24.

It should be understood that more than one core layer, reinforcement layer, and/or pre-pack may be placed on the polymer insert in the mold portion and step 212. It should also be understood that more than one or more insert may be placed in the mold portion. It should also be understood that one or more inserts may be placed at the periphery of the pre-pack and/or may be placed in a non-peripheral region of the body of the pre-pack. It should be further understood that one or more inserts may be placed in either a mold portion where it is held in place by gravity and/or a mold portion where the polymer insert is held into place by means known in the art, such as vacuum, adhesive, or interference fit.

### Example 1

Samples 1A and 1B are Sunshades Formed by Molding Approximately 870 gm of a polyurethane resin, a CSM fiberglass reinforcement layer, and a honeycomb core throughout the part. Extra polyurethane is used to fill a boss area. Samples 1C and 1D are sunshades made in the same mold as 1A and 1B using 742.5 gm of the same polyurethane resin as above, with a single backsheet having a weight of 300 gm/m². Samples 1E and 1F are sunshades made in the same mold as 1A and 1B using 755 gm of the same polyurethane resin as above, with a double backsheet having a combined weight of 600 gm/m². Samples 1G and 1H are sunshades made in the same mold as 1A and 1B using 757.5 gm of the same polyurethane resin as above, with a honeycomb having a weight of 300 gm/m². The average stiffness and the average stiffness per kilogram of the sunshades are given in FIG. 6.

### Example 2

Samples 1A, 1B, 1G, and 1H are conditioned for dimensional response to climate change testing. The average dimensional change before and after climate change conditioning of one cycle includes −40° C. for 24 hr to 90° C. for 24 hr. The average dimensional change for 1G and 1H is acceptable. The measured dimensional change is less than 0.9 mm in at least one embodiment. In at least one embodiment, the measured dimensional change is in a range from 0.5 mm to −0.35 mm. This unexpectedly improves on the stability of the component size of the component of the instant invention relative to the prior art samples, Samples 1A and 1B, which average a dimensional change is 1.7 mm. No delaminations are observed in the samples of the instant invention. In at least one embodiment, components of the instant invention grow in dimension instead of shrinking, which is unexpected because most cured thermoset resins in the curable layer 34 experience shrinkage under these test conditions. While not wishing to be bound by any one theory, the use of less thermoset resin, which expands the most of any material in the molded polymer part, has less total mechanical force available to drive expansion and contraction of the component.

### Example 3

Samples 1A, 1B, 1G, and 1H are conditioned for heat sag during painting in an automotive-type paint booth according to ASTM D3769. The average heat sag for experiencing painting before and after conditioning for 1G and 1H is acceptable, changing dimension in the range of −0.40 mm to 0.68 mm, and which averages 0.04 mm and is a surprising 1.60 mm less than the sagging of Samples 1A and 1B. In at least one embodiment, the average heat sag for the component of the instant invention ranges from −0.3 to 0.6 mm. While not wishing to be bound by any one theory, this unexpected improvement result appears to be the combination of at least three variables of the component, including the process to reduce the weight of cured resin in the curable layer 34, the raw material properties, and the ratio of weight of curable layer 34 to reinforcement layer 32.

### Example 4

Samples 1A-1H are loaded with increasing loads and the deflection is measured as shown in FIG. 6. The results are given in Table 1.

TABLE 1

| | AVERAGE STIFFNESS | AVERAGE STIFFNESS PER |
|---|---|---|
| SAMPLE | (N/mm) | KILOGRAM (N/mm/kg) |
| 1A-1B | 2.98 | 3.42 |
| 1C-1D | 2.99 | 4.04 |
| 1E-1F | 3.52 | 4.67 |
| 1G-1H | 4.01 | 5.29 |

The use of embodiments with core 30, reinforcement layer 32, and curable layer 34, such as in FIGS. 2A-2C, 2E, and 2F, the component of the instant invention is surprisingly stiffer on a weight basis than prior art components. In addition, the component made with the instant invention can be made with less than 86% of the prior art component weight (i.e. 1A-1B). In at least one embodiment, the weight of the component made with the instant invention can range from 50% to 95% of the prior art component weight. In another embodiment, weight of the component made with the instant invention can range from 75% to 90% of the weight of the prior art component.

In at least one embodiment, the stiffness per kilogram of the component made with the instant invention ranges from 17% to 75% stiffer per kilogram than the prior art component. In another embodiment, the component made with the instant invention ranges from 30% to 60% stiffer per kilogram than the prior art component.

In at least one embodiment, the stiffness of the component made with the instant invention ranges from 0.5% to 50% stiffer than the prior art component. In another embodiment, the component made with the instant invention ranges from 15% to 40% stiffer than the prior art component.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

We claim:

1. A molded polymer panel, comprising:
a core including a periphery;
a reinforcement layer having a first portion and a second portion, the reinforcement layer first portion enveloping the core, the reinforcement layer second portion extending from the reinforcement layer first portion away from the core periphery;
a curable layer having a first portion and a second portion, the curable layer first portion intermingled with the reinforcement layer first portion, and the curable layer second portion intermingled with the reinforcement layer second portion, wherein the core, reinforcement layer first portion, and the curable layer first portion form a sandwich core zone and the reinforcement layer second portion and the curable layer second portion form a stiffened zone.

2. The panel of claim 1, wherein the curable layer is a cured layer.

3. The panel of claim 2, wherein the average panel stiffness ranges from 4.04 N/mm of panel thickness/kg of panel to 5.29 N/mm of panel thickness/kg of panel.

4. The panel of claim 2, wherein the panel includes an uncompressed core subzone having a change in height of less than 10% of its original thickness.

5. The panel of claim 2, wherein the panel includes an uncompressed core zone that is an unbuckled, uncompressed core zone.

6. The panel of claim 2, wherein the panel has an average heat sag ranging from −0.3 mm to 0.6 mm when measured according to ASTM D3769.

7. The panel of claim 2, wherein the cured layer includes a polyurethane composition.

8. The panel of claim 2, wherein the core and the reinforcement layer define a cavity therebetween, the cavity being substantially devoid of the curable layer.

9. The panel of claim 2, further comprising:
a pre-molded insert disposed upon at least one of the curable layer or the reinforcement layer.

10. The panel of claim 9, wherein the pre-molded insert and the reinforcement layer define a cavity therebetween, the cavity being substantially devoid of the curable layer.

11. A molded polymer panel, comprising:
a core having a first surface and a second surface opposed and spaced apart from the first surface;
a first reinforcement layer adjacent to the first surface of the core;
a second reinforcement layer adjacent to the second surface of the core;
an insert adjacent to the first reinforcement layer and the first surface of the core, the insert and the first reinforcement layer defining a cavity;
a cured polymer layer encapsulating the first and second reinforcement layers and the insert, the cavity being substantially devoid of the cured polymer layer, wherein the panel average stiffness ranges from 4.04 N/mm of panel thickness/kg of panel to 5.29 N/mm of panel thickness/kg of panel.

12. The panel of claim 11, wherein the insert has a polymeric composition.

13. The panel of claim 11, wherein the reinforcement layer includes a fiberglass reinforcement.

14. The panel of claim 11, wherein the cured layer includes a lightweighting agent.

15. The panel of claim 14, wherein the lightweighting agent is present in an amount adapted to be sufficient to reduce the cured layer density to a range from 5% to 40% relative to the cured layer without the lightweighting agent.

16. The panel of claim 11, wherein the cured layer is present in the panel in an amount ranging from 200 g/m² to 2000 g/m².

17. The panel of claim 11, wherein the insert increases the thickness of the panel ranging from 1.5 times to 3.5 times the original panel thickness and the cured layer is preferentially thickened about the insert.

18. A method of manufacturing a panel, the method comprising the steps of:
providing a core and a reinforcement layer;
encapsulating the core with the reinforcement layer forming a prepack;
applying a thermoset layer to the reinforcement layer to form a wetted pre-pack;
placing the wetted pre-pack into a mold portion;
placing a pre-molded insert on to the wetted pre-pack, the pre-molded insert and the wetted pre-pack defining a cavity substantially devoid of the thermoset layer;
closing the mold portion;
applying pressure to form a molded panel;
curing the thermoset layer; and
removing the molded panel from the mold.

19. The method of claim 18, wherein the average panel stiffness ranges from 4.04 N/mm of panel thickness/kg of panel to 5.29 N/mm of panel thickness/kg of panel.

20. The method of claim 18, wherein the pre-molded insert increases the thickness of the panel ranging from 1.5 times to 3.5 times the panel thickness without the insert and the thermoset layer is preferentially thickened about the insert.
